(19) United States
(12) Patent Application Publication
(10) Pub. No.: US 2004/0012121 A1
(43) Pub. Date: Jan. 22, 2004

(54) Fiber-reinforced thermoplastically molded articles

(76) Inventors: Steffen Lang, Koln (DE); Detlev Joachimi, Krefeld (DE); Klaus Konejung, Bergisch Gladbach (DE); Maarten De Bock, Kalmthout (BE)

Correspondence Address: BAYER POLYMERS LLC, 100 BAYER ROAD, PITTSBURGH, PA, 15205, US

(21) Appl. No.: 10/619,316

(22) Filed: Jul. 14, 2003

(30) Foreign Application Priority Data
Jul. 19, 2002 (DE) 10232485.9

(51) Int. Cl. B29C 43/00

(52) U.S. Cl. 264/325; 264/328.18

(57) ABSTRACT

A process for making a fiber reinforced molded article is disclosed. The process entails (i) melting a thermoplastic resin (ii) introducing and homogeneously distributing at least one fiber strands to the molten resin to form a mixture of fibers and molten resin and (iii) molding the article by injection or by compression molding, and (iv) solidifying the article. The process is characterized in that where the fiber strands have a fiber length of 2 to 25 mm and in that the molded article contains fibers the mean length of which is at least 400 μm. Lastly the process is characterized in that no cooling or solidifying take place between steps (ii) and (iii).

### FIELD OF THE INVENTION

The present invention relates to the molded plastic articles and more particularly to fiber reinforced plastic articles.

### SUMMARY OF THE INVENTION

A process for making a fiber reinforced molded article is disclosed. The process entails (i) melting a thermoplastic resin (ii) introducing and homogeneously distributing at least one fiber strands to the molten resin to form a mixture of fibers and molten resin and (iii) molding the article by injection or by compression molding, and (iv) solidifying the article. The process is characterized in that where the fiber strands have a fiber length of 2 to 25 mm and in that the molded article contains fibers the mean length of which is at least 400 μm. Lastly the process is characterized in that no cooling or solidifying take place between steps (ii) and (iii).

### BACKGROUND OF THE INVENTION

The invention describes a process for the production of glass- and/or carbon-fiber-reinforced moldings, wherein the average fiber length is markedly greater than the fiber length that is obtainable in the conventional injection-molding process using conventionally compounded thermoplastic molding compositions of otherwise identical composition. The process is characterized in that there is first produced a polymer melt into which conventional chopped fibers (chopped strands, having mean fiber length of <10 mm) are incorporated, and the resulting melt is transferred to an injection-molding unit or a press and then brought into the desired form by injection molding, compression molding or comparable processes. It is critical that the melt does not solidify again after incorporation of the fibers and does not have to be melted again before being shaped. The process can in principle also be transferred to extrusion processes such as profile extrusion and blow molding. There come into consideration as the reinforcing material also other fibrous materials that can be metered in chopped form with average fiber lengths <25 mm.

There is in principle an interest in processes for the production of fiber-reinforced moldings from thermoplastic molding compositions which permit as great an average fiber length as possible, because the mechanical properties, especially rigidity and strength, are influenced thereby in a positive manner. The process should be applicable as universally as possible and at the same time should require minimal outlay in terms of manual labour and raw material costs.

For the production of moldings reinforced with long glass fibers there are used, for example, long-fiber-reinforced granules or pellets (typical lengths are, for example, from 12 to 25 mm), which are produced by pultrusion processes. A disadvantage is that high mechanical stresses, which lead to breakage of the long fibers, occur during the melting process in the processing of such pultruded products on injection-molding machines. Only a small fraction of long glass fibers is retained. The mean fiber length in the molding can be increased by gentle processing conditions, for example the use of screws with low compression and a high length/diameter ratio, low back pressure, a rate of injection that is as low as possible and appropriate non-return valves. An increase in the mean glass fiber length is also possible by measures relating to tool design, such as the use of a rod-type runner system that is as large as possible and the avoidance of sharp changes in direction in the melt channel.

In order partly to solve the problem of breakage of the glass fibers during the critical melting process, so-called direct compounding processes have been developed, in which the thermoplastic plastic is first melted in a twin-screw extruder. The fibrous reinforcing materials are then metered in and mixed into the molten plastics matrix. This process can be carried out continuously (with the aid of a melt accumulator) or discontinuously. After compounding, the plastics/fiber mixture is transferred to a plunger-type injection unit and then injected into the shaping tool by means of an injecting plunger.

In a further known process, the thermoplastic plastic is first melted in a twin-screw extruder and the melt, together with the reinforcing fibers, is then conveyed to a second twin-screw device. In that device, the two components are compounded. The mixture is subsequently discharged in the form of an extrudate, is cut to length and is fed by means of a handling system to a press. A particular embodiment of that process, in which glass fibers having a length of at least 25 mm are used for the reinforcement, is described in U.S. Pat. No. 5,165,941.

The known processes for the production of moldings reinforced with long glass fibers have the disadvantage that it is necessary in all cases to use long glass fibers which are unwound from rovings during the compounding operation, for example. The handling of rovings is substantially more complex compared with the gravimetric metering of chopped glass fibers (fiber length not more than 6 mm).

The basis of all existing processes is that, in order to achieve a significantly greater glass fiber length in comparison with conventional processing by injection molding, it is necessary to use continuous fibers (so-called rovings) or glass fibers that are very long (in the case of the process described in U.S. Pat. No. 5,165,941 glass fibers having a length of at least 25 mm) at least in comparison with commercially available chopped glass fibers (so-called chopped strands having a length of from 3 to 6 mm).

However, it has now been found, surprisingly, that, even when relatively short fibers, so-called chopped strands, are used, it is possible, by the use of suitable processes, to achieve fiber lengths in the molding that are significantly greater than those which can be achieved in the processing of conventional compounds by the standard injection-molding process. The only requirement for success is that the corresponding glass fibers or carbon fibers are incorporated gently into the thermoplastic melt and the melt is processed further gently (preferably immediately), especially without intermediate solidification and/or crystallisation of the molding composition.

Particular preference is given to processes in which twin-shaft extruders (for example, so-called ZSK from KWP) or kneaders are used for the compounding step, and the injection unit is a plunger-type injection-molding machine.

There are suitable for the process according to the invention in principle any thermoplastics in which it is expedient to use glass- or carbon-fiber reinforcement or similar reinforcing materials. Particularly suitable are commercial thermoplastics, such as, for example, polyamides, polyalkylene terephthalates, blends of different commercial thermoplastics with one another or with impact-modifying blend partners. In addition, the process is also suitable for high-performance thermoplastics, such as, for example, polyphenylene sulfide.

The thermoplastic molding compositions can comprise the additives conventionally employed, such as processing aids (lubricants and mold release agents), elastomer modifiers, flameproofing agents, nucleating agents (in the case of semi-crystalline polymers), colourants, carbon blacks, conductivity additives, antistatics, plasticisers, and further fillers and reinforcing materials, especially mineral fillers.

The addition of those substances should, of course, preferably be carried out in such a manner that damage to the fibers added in accordance with the invention remains as slight as possible.

Fibrous reinforcing material within the scope of the invention is understood as being especially glass fibers, carbon fibers, steel fibers, metallised glass fibers, natural fibers and polymer fibers, provided they are used in the form of a fiber strands having a mean fiber length of preferably from 2 to 25 mm, particularly preferably from 3.5 to 6 mm, are compatible with the molding composition in question and—in the case of polymer fibers—do not dissolve in the molding composition or melt at the appropriate processing temperatures.

In the most preferred process variant, chopped glass fibers, so-called chopped strands, having a length of from 3 to 6 mm are used. Particularly preferred thermoplastics are polyamides—especially polyamide 6 and polyamide 66, polybutylene terephthalate and blends thereof with polycarbonate and or rubbers.

Very many methods have become known for the preparation of polyamides, in which methods it is possible to use, depending on the desired end product, different monomeric structural units, different chain regulators for establishing a desired molecular weight, or alternatively monomers having reactive groups for subsequently intended aftertreatments.

The technically relevant processes for the preparation of polyamides preferably take place via polycondensation in the melt. In this context, the hydrolytic polymerisation of lactams is also to be understood as polycondensation.

Preferred polyamides are semi-crystalline polyamides, which can be prepared starting from diamines and dicarboxylic acids and/or lactams having at least 5 ring members or corresponding amino acids.

There come into consideration as starting materials aliphatic and/or aromatic dicarboxylic acids, such as adipic acid, 2,2,4- and 2,4,4-trimethyladipic acid, azelaic acid, sebacic acid, isophthalic acid, terephthalic acid, aliphatic and/or aromatic diamines, such as, for example, hexamethylenediamine, 1,9-nonanediamine, 2,2,4- and 2,4,4-trimethylhexamethylenediamine, the isomeric diamino-dicyclohexyl-methanes, diaminodicyclohexylpropanes, bis-aminomethyl-cyclohexane, phenylenediamines, xylylenediamines, aminocarboxylic acids, such as, for example, aminocaproic acid, or the corresponding lactams. Copolyamides consisting of a plurality of the mentioned monomers are included. Special preference is given to the use of caprolactams, most particularly preferably ε-caprolactam.

Also particularly suitable are compounds based on PA6, PA66 and other aliphatic and/or aromatic polyamides or copolyamides, in which compounds there are from 3 to 11 methylene groups per polyamide group in the polymer chain.

The polyamides that are used may also be employed in admixture with other polyamides and/or further polymers.

The polyamide molding compositions may additionally comprise fireproofing agents, such as, for example, phosphorus compounds, organic halogen compounds, nitrogen compounds and/or magnesium hydroxide, stabilisers, processing aids, such as, for example, lubricants, nucleating agents, impact modifiers, such as, for example, rubbers or polyolefins and the like.

### EXAMPLES

### Example 1

Production according to the invention of moldings of PA6GF30 (with 30 wt. % glass-fiber-reinforced polyamide 6). For the preparation of the molding composition according to the invention, PA6 (Durethan® B31 SK H2.0 900050; commercial product of Bayer AG, Leverkusen, Germany) was metered into the intake region of a twin-screw extruder which was connected to a twin-plunger injection system. The addition of the chopped glass fibers CS 7928 (commercial product of Bayer AG, Leverkusen, Germany) into the molten molding composition was carried out continuously by means of a gravimetric metering unit. After compounding, the plastics/fiber mixture was transferred to a plunger-type injection unit and then injected by means of an injecting plunger into the injection-molding tool (molding weight approx. 700 g; wall thickness of approx. 3 mm). The twin-plunger injection system ensured continuous operation of the twin-screw extruder. In the case of the twin-plunger injection system, the composition compounded during the injection was transferred to the non-active plunger-type injection unit.

### Example 2

### Comparison Example to Example 1

Production of moldings of PA6GF30 using conventional injection-molding material. For the production of the corresponding moldings, PA6GF30 (Durethan® BKV30 H2.0 900050; commercial product of Bayer AG) was processed to moldings on an injection-molding machine under standard conditions by the standard injection-molding process with the aid of the injection-molding tool described in Example 1.

### Example 3

Production according to the invention of moldings of PA66GF30. For the preparation of the molding composition according to the invention, thermostabilised black-dyed PA66 (Durethan® A 30 S H2.0 900050; commercial product of Bayer AG) was metered into the intake region of the device described in Example 1. The addition of the chopped glass fibers CS 7928 (commercial product of Bayer AG) into the molten molding composition was carried out continuously by means of a gravimetric metering unit. After compounding, the plastics/fiber mixture was transferred to a plunger-type injection unit and then processed to moldings with the aid of the injection-molding tool described in Example 1.

### Example 4

### First Comparison Example to Example 3

Production of moldings of PA66GF30 using conventional injection-molding material. For the production of the corresponding moldings, PA66GF30 (Durethan® AKV30 H2.0 900050; commercial product of Bayer AG) was processed to moldings on an injection-molding machine under standard conditions by the standard injection-molding process with the aid of the injection-molding tool described in Example 1.

### Example 5

### Second Comparison Example to Example 3

Production, not according to the invention, of moldings of PA66GF30 using continuous glass fibers (having a fiber diameter of 11 μm). For the preparation of the molding composition, PA66 (Durethane® A 30 S H2.0 900050; commercial product of Bayer AG) was metered into the intake region of the twin-screw extruder of the device described in Example 1. The addition of the continuous glass fibers was carried out in the twin-screw extruder. The fibers were incorporated into the already molten molding composition. The glass fiber concentration could be varied via the amount of thermoplastic metered in, the screw speed, the so-called tex number of the fibers (the tex number is a measure of the number of individual fibers bundled in a fiber strand) or the number of so-called rovings (windings of the fiber strands) used.

The metering of continuous fibers required more outlay in terms of handling than the metering of chopped glass fibers, which was possible without difficulty by means of gravimetric weighing. After compounding, the plastics/fiber mixture was transferred to a plunger-type injection unit and then processed to moldings with the aid of the injection-molding tool described in Example 1.

Square sheets of edge lengths 55 times 55 times 3 mm³ and flat rods of edge lengths 80 times 10 times 3 mm³ were removed from the moldings and tested for mechanical properties and glass fiber length distribution. The results are summarised in Table 1.

A comparison of the examples according to the invention with the comparison examples shows that the strength, modulus, resilience in the biaxial penetration test and the glass fiber length have markedly higher values than in the case of the comparison tests.

TABLE 1

| | | Exam- | | Exam- | Exam- |
|---|---|---|---|---|---|
| | | ple 2 | | ple 4 | ple 5 |
| | | (com- | | (com- | (com- |
| | | pari- | | pari- | pari- |
| | | son to | | son to | son to |
| | Example | Exam- | Example | Exam- | Exam- |
| | 1 | ple 1) | 3 | ple 3) | ple 3) |
| Bending stress | 200 | 171 | 208 | 172 | 179 |
| at 3.5% | | | | | |
| Outer fiber | | | | | |
| strain [Mpa] | | | | | |
| Flexural | 220 | 195 | 246 | 202 | 228 |
| strength [Mpa] | | | | | |
| Bending | 6590 | 5520 | 6320 | 5470 | 5910 |
| modulus [Mpa] | | | | | |
| Mean value of | approx. | approx. | approx. | approx. | approx. |
| the glass fiber | 420 | 270 | 490 | 270 | 830 |
| length | | | | | |
| distribution [μm] | | | | | |

The table shows that the important mechanical properties of bending stress, flexural strength and bending modulus have significantly higher values in the case of the moldings according to Example 1 and Example 3 produced in accordance with the invention. The mean value of the glass fiber length distribution in the case of Example 3 according to the invention is markedly higher than the mean value which can be achieved when processing ready-made compound having the same glass fiber concentration (Example 4). Although the glass fiber length of the compound produced using continuous glass fibers (Example 5) is greater than in the case of Example 3, better mechanical characteristic values are achieved in Example 3.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for making a fiber reinforced molded article comprising
(i) melting a thermoplastic resin,
(ii) introducing and homogeneously distributing at least one fiber strands to the molten resin to form a mixture of fibers and molten resin and
(iii) molding the article by injection or by compression molding, and
(iv) solidifying the article,
where the fiber strands have a fiber length of 2 to 25 mm and where the molded article contains fibers the mean length of which is at least 400 μm, said process characterized in the absence of cooling or solidifying between said (ii) and (iii).

2. The process of claim 1 where the fibers bundle contains fibers having a mean diameter of 9 to 17 μm.

3. The process of claim 1 where the fibers bundle contains fibers having a mean diameter of 6 to 17 μm.

4. The process of claim 1 wherein the thermoplastic resin comprise polyamide.

5. The process of claim 4 wherein the polyamide is at least one member selected from the group consisting of PA6 and PA66.

6. The process of claim 1 wherein the thermoplastic resin comprise polyester.

7. The process of claim 6 wherein the polyester is polybutylene terephthalate.

8. The process of claim 6 wherein the polyester is polyethylene terephthalate.

9. The process of claim 1 wherein the thermoplastic resin is polypropylene.

10. The article prepared by the process of claim 1.
